(19) United States
(12) Patent Application Publication
(10) Pub. No.: US 2019/0332996 A1
(43) Pub. Date: Oct. 31, 2019

(54) MERCHANDISING INITIATIVE MANAGEMENT SYSTEM

(71) Applicant: CLEARVIEW RETAIL, L.L.C., Needham, MA (US)

(72) Inventor: Thomas L. O'Brien, Needham, MA (US)

(21) Appl. No.: 16/396,364

(22) Filed: Apr. 26, 2019

Related U.S. Application Data
(60) Provisional application No. 62/663,815, filed on Apr. 27, 2018.

(51) Int. Cl. G06Q 10/06; G06Q 10/10

(52) U.S. Cl. CPC G06Q 10/063112; G06Q 10/1097

(57) ABSTRACT

A merchandising initiative management system includes a management controller. The management controller is configured to electronically interface with at least one workforce management platform, at least one merchandising requestor management platform, and at least one associate platform. The management controller is configured to receive a service request to initiate a merchandising project. The service request includes at least one location and a performance time range. Furthermore, the management controller is configured to receive associate data from the workforce management platform of at least one selected location. The associate data relates to a work schedule of at least one associate that works at the selected location. The associate data includes the times and the dates the at least one associate is scheduled to work at the selected location. The management controller is configured to selectively enable use of an associate platform as a function of the work schedule of the associate.

### CROSS-REFERENCE TO RELATED APPLICATIONS

This patent application claims priority from provisional U.S. patent application No. 62/663,815, filed Apr. 27, 2018, entitled, “MERCHANDISING INITIATIVE MANAGEMENT SYSTEM,” and naming Thomas L. O'Brien as inventor, the disclosure of which is incorporated herein, in its entirety, by reference.

### FIELD OF THE INVENTION

Various embodiments of the invention generally relate to merchandising and, more particularly, various embodiments relate to a technology for engaging retail associates for in-store merchandising initiatives.

### BACKGROUND OF THE INVENTION

At the retail store level, merchandising refers to displaying products in the store to stimulate interest and maximize product purchases. Because of the significance of shelf-space, the retailer and/or the supplier (e.g., brand, manufacturer, etc.) may have merchandising initiatives, e.g., a certain way they wish a particular product to be displayed.

### SUMMARY OF VARIOUS EMBODIMENTS

In accordance with one embodiment of the invention, a merchandising initiative management system includes a merchandising initiative management controller. The merchandising initiative management controller is configured to electronically interface with at least one retailer workforce management platform, at least one merchandising requestor management platform, and at least one associate platform. The management controller is further configured to receive a merchandising service request from a merchandising requestor platform. The service request has specifications including a task and a selected retail location for performance of the task. Furthermore, the management controller is configured to receive associate data from the workforce management platform of the selected retail location. The associate data relates to a work schedule of a retail associate that works at the selected retail location. The management controller is further configured to assign at least one retail associate to the service request, thereby defining an assigned associate. The management controller is also configured to selectively enable use of the associate platform of the assigned associate as a function of the work schedule of the assigned associate.

In some embodiments, the associate data includes the times and the dates the at least one retail associate is scheduled to work at the selected retail location. Additionally, or alternatively, the associate data may include an indication of whether the associate is working at the time the management controller requests the data. The management controller may request the associate data, for example, at the time the associate tries to perform the service request. Additionally, or alternatively, the management controller may request the associate data, for example, at the time the associate tries to access the associate platform.

In some embodiments, the associate platform is enabled when the associate is not actively working on behalf of the retailer. In some embodiments, the service requests also includes a pay rate and is received from the merchandising requestor management platform. The time for performance of the service request may be a time and/or date range. Additionally, or alternatively, the time for performance of the service request may specify a deadline by which the service request needs to be completed.

The management controller may compare the specifications in the service request with the associate data of the retail associate. By so doing, the management controller may determine that one or more qualified associates match and/or meet the specifications. The management controller may provide an invitation to perform service request to the one or more qualified associates through the associate platform. The management controller may also receive an acceptance of the invitation to perform service request from one or more of the qualified associates.

The service request specification may include a plurality of retail locations. For example, the merchandising requestor may select a clustered group of retail locations. In some embodiments, a plurality of retail associates may be assigned to the plurality of retail locations, respectively.

Furthermore, in some embodiments the service request is transmitted to qualified associates over a wireless communication channel to a wireless device associated with the at least one qualified retail associate, as a function of the work schedule of the retail associate. Furthermore, in some embodiments, the transmitted service request activates the associate platform to cause the service request to display on the wireless device and to enable connection via the management controller when the wireless device is connected to the internet.

Additionally, in some embodiments, the management controller is configured to access a GPS system of a wireless device of the associate to determine whether the associate is at the selected location. If the associate is not at the selected location, then a directive and/or reporting portion of the associate platform may be disabled. Additionally, or alternatively, if the associate is scheduled to work for the retailer, then the associate platform may be disabled.

In accordance with another embodiment of the invention, a method of booking a merchandising service requests includes providing a merchandising initiative management controller. The merchandising initiative management controller is configured to electronically interface with at least one retailer workforce management platform, at least one merchandising requestor management platform, and at least one associate platform. The merchandising initiative management controller is configured to receive the scheduled work shift of the retail employees. The merchandising initiative management controller allows a merchandising requestor to create a service request including a retail location, and a performance time range. The management controller qualifies retail employees that meet the requirements in the service request, thereby producing a list of qualified retail employees. The qualified retail employees are invited to perform the service request, and the management controller receives an input from the qualified retail employees as to whether they accept or decline the service request, and the service request is assigned to at least one qualified employee, who is referred to as an assigned employee Illustrative embodiments disable use of the associate platform of the assigned employee during the scheduled shift of the assigned employee.

Among other things, the service request may include associate skills and/or pay rate. The service request may be created from the merchandising requestor management platform. The associate data may include a full-time or part-time, salaried or hourly status indicator for the retail associate, associate tenure, and/or associate skills.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 shows shelf space inside of a retail store that may be used in accordance with illustrative embodiments of the invention.

FIG. 2 schematically shows a merchandising initiative management system in accordance with illustrative embodiments of the invention.

FIG. 3 shows a process of creating and completing a merchandising initiative service request in accordance with illustrative embodiments of the invention.

FIG. 3A shows a process of the step of creating service requests in is FIG. 3.

FIG. 3B shows a detailed process of the step of identifying qualified retail associates in FIG. 3.

FIG. 4 shows a screenshot of an exemplary interface for creating a service request on the merchandising requestor management platform in accordance with illustrative embodiments of the invention.

FIG. 5 shows a screenshot of an exemplary interface for creating tasks for the service request using the merchandising requestor management platform in accordance with illustrative embodiments of the invention.

FIG. 6 shows a screenshot of an exemplary interface for selecting retail locations for the service request in accordance with illustrative embodiments of the invention.

FIG. 7 shows a screenshot of an exemplary interface for selecting desired skills for the service request in accordance with illustrative embodiments of the invention.

FIG. 8 shows a screenshot of an exemplary interface for selecting a time for performance of the service request in accordance with illustrative embodiments of the invention.

FIG. 9 shows a screenshot of an exemplary notification message informing the merchandising requestor that the service request was successfully created in accordance with illustrative embodiments of the invention.

FIGS. 10A-10C show screenshots of an exemplary interface of the associate platform for viewing service requests in accordance with illustrative embodiments of the invention.

FIG. 11 shows a screenshot of an exemplary interface on the retail associate platform for accepting the service request in accordance with illustrative embodiments of the invention.

FIG. 12A shows a screenshot of an exemplary GPS interface of the retail associate platform in accordance with illustrative embodiments of the invention.

FIG. 12B shows an example of a message informing the retail associate that they are at the wrong location in accordance with illustrative embodiments of the invention.

FIGS. 13A-13B show screenshots of an exemplary interface for preparing a report in accordance with illustrative embodiments of the invention.

FIG. 14 shows details of the controller in accordance with illustrative embodiments of the invention.

### DESCRIPTION OF ILLUSTRATIVE EMBODIMENTS

In illustrative embodiments, a merchandising initiative management system enables creation and fulfillment of ad hoc merchandising service requests that provide various advantages to suppliers, retailers, and employees of the retailer. Specifically, merchandising requestors (e.g., suppliers) create service requests, using the management system, for merchandising initiatives in selected retail locations at selected times. The requests are sent to qualified retail employees (also referred to as qualified retail associates) through the management system. To determine whether a retail associate is qualified, the management system communicates with a workforce management platform of the retailer. The system confirms whether the retail associate is qualified by checking, among other things, that the retail associate is employed by the retailer. Additionally, the system enables completion of the service request during times when the retail associate is available (e.g., not during a scheduled work shift at the retailer, when the retailer is closed, etc.). Details of illustrative embodiments are discussed below.

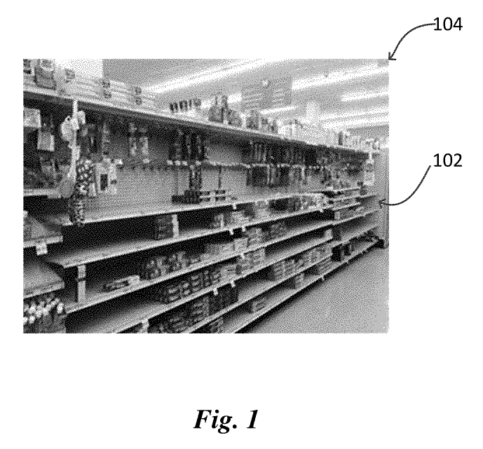

FIG. 1 shows shelf space 102 inside of a retail store 104 that may be used in accordance with illustrative embodiments of the invention. Merchandising requestors, such as manufacturers, private label brands, distributors, etc. (referred to as “suppliers” for convenience), may wish to have items they are selling occupy the shelf space 102. Increasingly, retail shelf space 102 is becoming more and more competitive. Retailers frequently charge suppliers slotting fees to have their product placed on the retail shelf 102 (e.g., especially in prime shelf 102 space). Additionally, retailer economics are such that products that are not selling at a good velocity are discontinued from the retailer and/or require additional slotting fees. Accordingly, the retailer and the supplier have incentive to provide merchandising initiatives that position products on the shelf 102 in a way that is likely to increase sales velocity.

Despite this incentive on both parties, as shown in FIG. 1, some of the shelf space 102 may be empty. Additionally, or alternatively, items may be arranged poorly on the shelf 102, or not in the manner preferred by the merchandising requestor. To deal with these issues, the merchandising requestor may send in-house team members or hire a third party merchandiser to ensure that the items are stocked and/or displayed appropriately (referred to as merchandising). Hiring in-house team members or third party merchandisers can be prohibitively expensive for companies, especially startup or smaller companies. Generally, startup companies are not sufficiently capitalized to afford an in-house team or to hire a contractor to perform the merchandising requests. Many times startup founders attempt to perform the merchandising initiatives themselves. This can be especially difficult if the products are sold in a national chain (e.g., all across the country).

In addition to the financial and logistical expense described above for suppliers, conducting and contracting merchandising initiatives can be limited by the contractor's schedule and geographic location. Additionally, from the perspective of the retailer, this has the undesirable consequence of bringing outside parties onto the retail store 104 premises to adjust the merchandising of certain products. Having third parties adjust the merchandising may be against retailer policies and also may make retailers uncomfortable (e.g., a small retail location may not allow third parties to adjust merchandising displays).

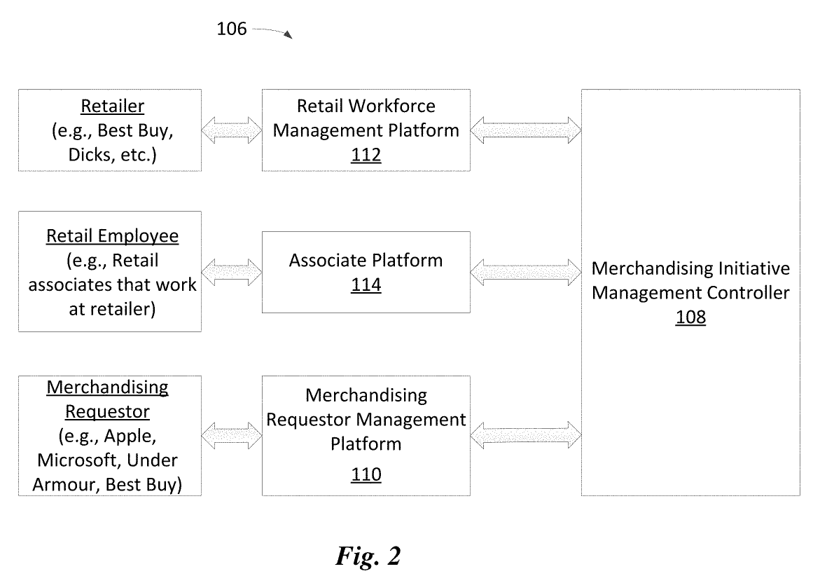

FIG. 2 schematically shows the merchandising initiative management system 106 in accordance with illustrative embodiments of the invention. The merchandising initiative management system 106 allows merchandising requestors to send merchandising initiative service requests to qualified employees (e.g., retail associates) that already work for the retailer (e.g., Best Buy) at which the service request is to take place. In some embodiments, the service request may search for qualified employees that work at the specific retail locations 104 (e.g., Best Buy in Braintree, Mass.). In some other embodiments, where third party contractors have been approved by a retailer in the management system 106, they may also be considered qualified employees.

The system 106 has a controller 108 that interfaces and communicates with a platform from each of the relevant parties (i.e., a merchandising requestor platform 110, a retailer platform 112, and a retail associate platform 114). This communication may occur over a network (e.g., within a local area network, a wide area network, or the Internet, to name but a few examples). Although the various platforms may be described as separate platforms, it should be understood that one or more of the platforms may be combined/integrated. For example, the retailer platform 112 and the associate platform 114 may be integrated in a single platform on the retailer's internal computer network. As another example, all three platforms 110, 112, and 114 may be integrated into a single platform and offered to each user (i.e., retailer, supplier, and associate), with each user only having access to their relevant portion (i.e., the retailer can access the workforce management platform 112 portion, the user can access the associate platform 114 portion, and the merchandiser can access the merchandising request management platform 110 portion). In some embodiments, one or more of the platforms 110-114 may be implemented as a web-enabled application (e.g., at a particular URL), software program, and/or smartphone enabled application. Thus, the respective user may access one or more of the platforms 110-114 through a network-connected computing device (e.g., computer, smart phone, laptop, etc.).

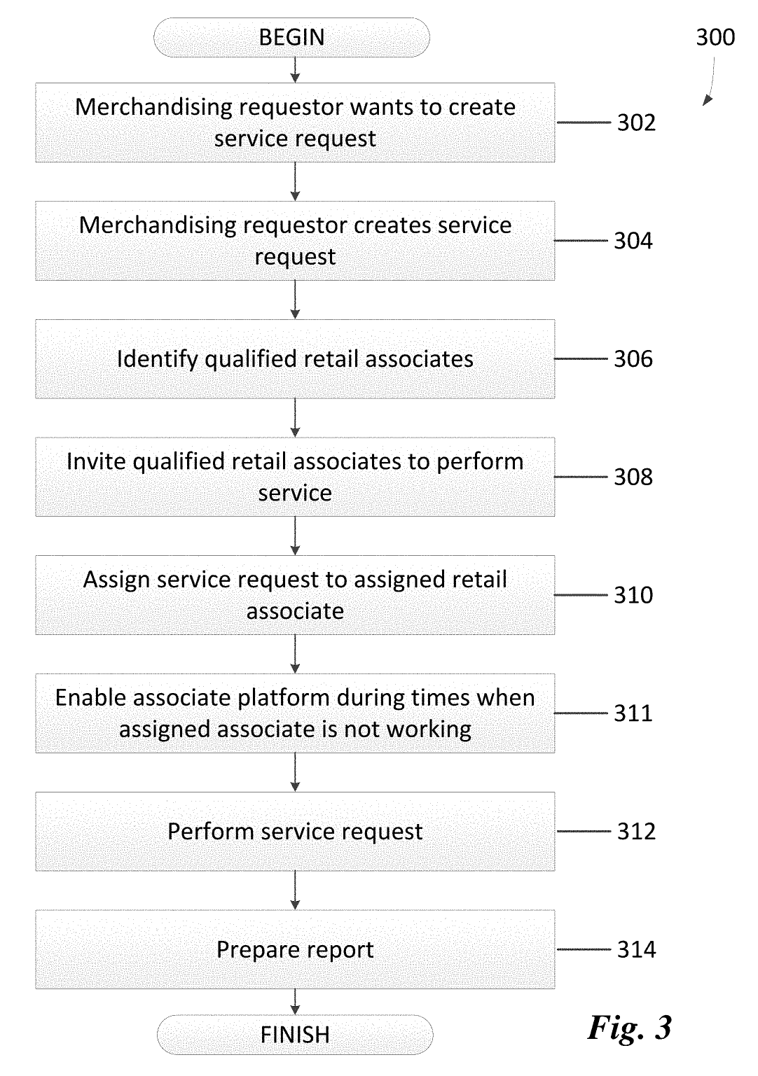

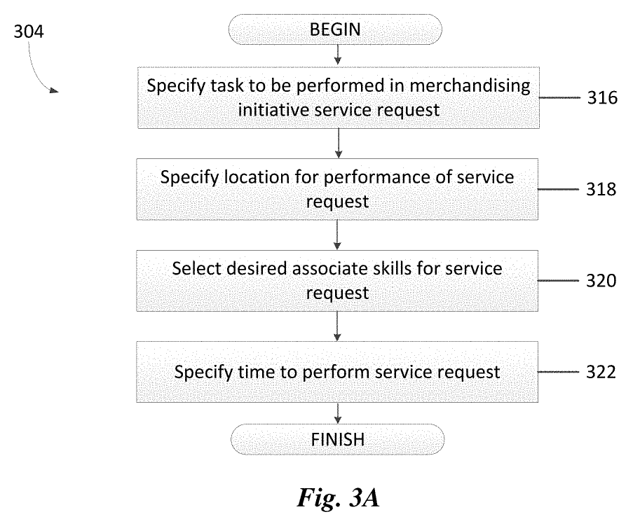

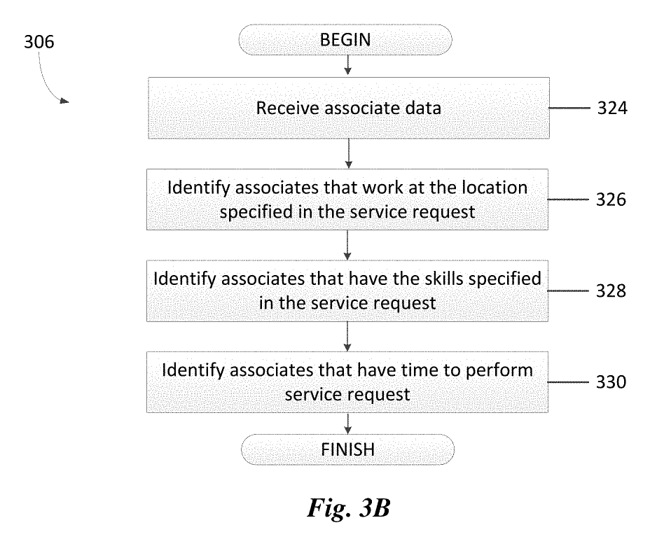

FIG. 3 shows a process 300 of creating and completing a merchandising initiative service request in accordance with illustrative embodiments of the invention. It should be noted that this method is substantially simplified from a longer process that may normally be used. Accordingly, the method of FIG. 3 may have many other steps that those skilled in the art likely would use. In addition, some of the steps may be performed in a different order than that shown, or at the same time. Furthermore, some of these steps may be optional in some embodiments. Accordingly, the process 300 is merely exemplary of one process in accordance with illustrative embodiments of the invention. Those skilled in the art therefore can modify the process as appropriate.

The process 300 begins at step 302, where a merchandising requestor determines that they want to create a merchandising service request. As an example, the merchandising requestor may desire to have their merchandising serviced on a repeating schedule (e.g., weekly, bi-weekly, monthly, quarterly, semi-annually, annually, etc.). As an additional example, the merchandising requestor may identify a problem with the merchandising of a product that they produce or distribute (e.g., product sales low in particular location, visual inspection, etc.). Merchandising requestors generally can be thought of as the manufacturer, brand name, distributor, or other party that sells a product to a retailer. For example, the merchandising requestor, Under Armour, may sell apparel at the retail store The Sports Authority. Under Armour may desire that their apparel is merchandised in a specific manner, e.g., a display of a mannequin in a running position wearing a particular shirt, shorts, socks and/or shoe combinations. The merchandising requestor (in this example Under Armour) can create a service request to confirm that the merchandising initiative (in this example a mannequin in a running position wearing the desired apparel) is executed correctly.

In some embodiments, the merchandising requestor and the retailer may be the same entity. For example, Dick's Sporting Goods (“Dick's”), a retailer, may have private label items that are also sold at Dick's. In this example, Dick's may desire that their own products are displayed in a certain manner. Additionally, or alternatively, Dick's may desire to merchandise an Under Armour product in a certain way (absent input from Under Armour). Accordingly, in some embodiments, the merchandising requestor management platform 110 and the retailer workforce management platform 112 may, but are not required to be, integrated into a single platform that communicates with the merchandising initiative management controller. Additionally, the retailer may have an in-house associate platform 114 for its own employees. Thus, the associate platform 114 may, but is not required to be, integrated into a single platform with the retailer workforce management platform 112 and/or the merchandising requestor management platform 110.

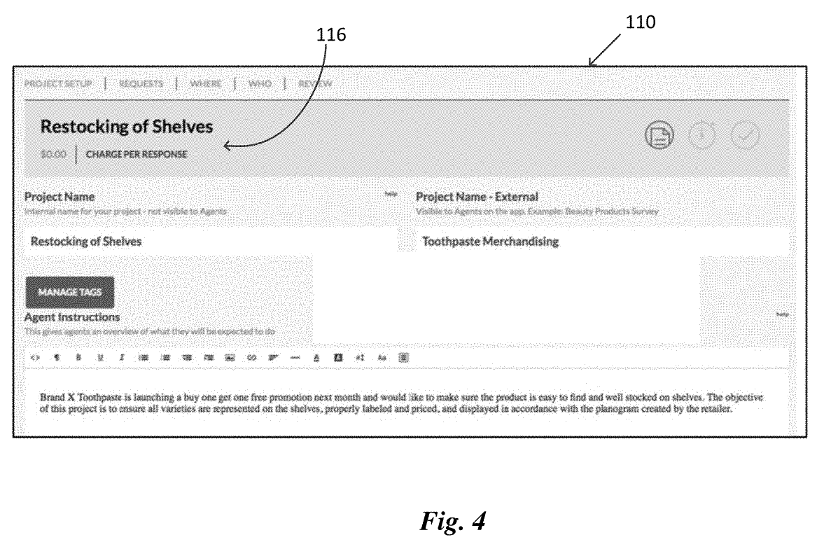

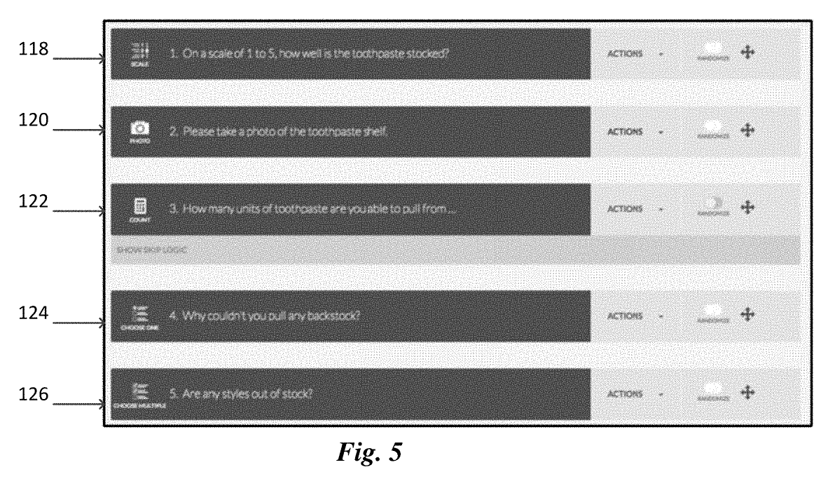

To that end, the merchandising requestor creates the service request using the merchandising requestor management platform 110 at step 304. FIG. 4 shows a screenshot of an exemplary interface for creating the service request 116 (also referred to as a “project”) on the merchandising requestor management platform 110 in accordance with illustrative embodiments of the invention. The merchandising requestor can enter, in some embodiments, an internal project name that is not visible to retail associates (also referred to as “associates”), an external project name that is visible to associates, and instructions for the project, among other things. As discussed in more detail with respect to FIG. 5 below, the merchandising requestor can create specific tasks, questionnaires, and provide details for successful execution of the service request 116. Furthermore, the merchandising requestor can set a pay rate for the service request 116. In some embodiments, the inputted pay rate may be required to meet or exceed the federal or state mandated minimum wage.

FIG. 3A shows a detailed process of step 304, which creates the service request. Steps 316-322 describe a number of specifications that may be included in the service request 116. At step 316, the process asks the merchandising requestor to specify the task to be performed in the merchandising initiative service request 116. It should be noted that the method shown in FIG. 3A is substantially simplified from a longer process that may normally be used. Accordingly, the method of FIG. 3A may have many other steps that those skilled in the art likely would use. In addition, some of the steps may be performed in a different order than that shown, or at the same time. Furthermore, some of these steps may be optional in some embodiments. Accordingly, the process 304 is merely exemplary of one process in accordance with illustrative embodiments of the invention. Those skilled in the art therefore can modify the process as appropriate.

FIG. 5 shows a screenshot of an exemplary interface for creating tasks for the service request 116 using the merchandising requestor management platform 110 in accordance with illustrative embodiments of the invention. For example, the service request 116 may ask the associate to answer a questionnaire 118 (e.g., rate how well the item is stocked). Additionally, the service request 116 may ask the retail associate to take a photo 120 of the shelf 102 (e.g., when the item is stocked as is and/or after the associate has performed certain tasks), pull units of the item 122 from backstock (e.g., to add more stock to) or pull units from the shelf 102 (e.g., if the packaging is damaged), provide detailed feedback 124, and/or determine whether and/or why particular SKUs or styles are out of stock 126. Other tasks in the service request 116 may include, for example, stocking retail shelves (“pulling backstock”), installing signage (Point of Purchase materials or “POP”), arranging products in accordance with a particular layout (planogram), auditing store adherence to seasonal or promotional plans and correcting any issues that are discovered, removing recalled items from shelves and shipping back to merchandising requestor, corrective actions on mislabeled products, inconsistent pricing, broken fixtures, incorrect location, training peers on a new product feature and/or other activities that present products in a manner consistent with ongoing brand and store initiatives.

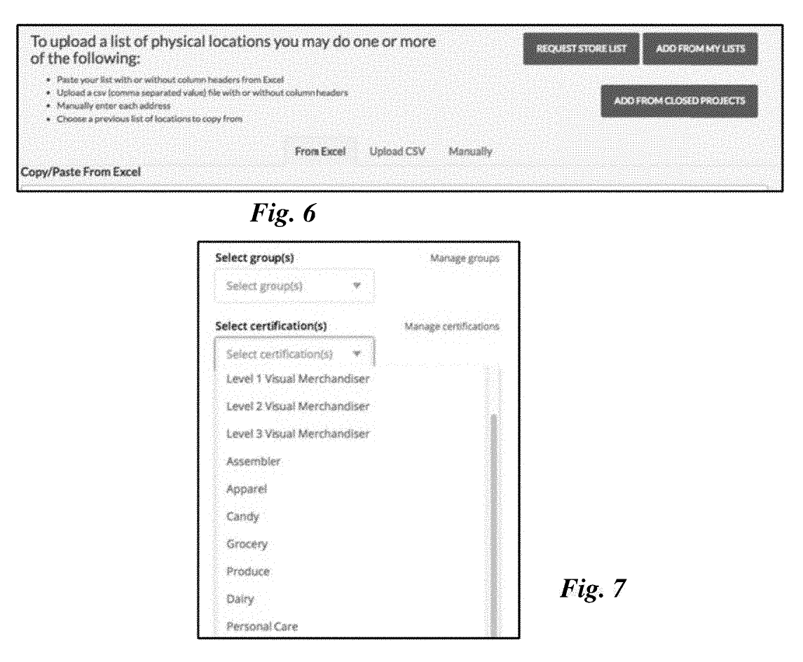

FIGS. 6-8 show screenshots of steps 318-322, respectively. Specifically, FIG. 6 shows a screenshot of an exemplary interface for selecting retail locations for the service request 116 as in step 318. The merchandising requestor can request a list of stores, add stores from a previously created list (e.g., Excel document, CSV document, or from previously created list on merchandising requestor management platform 110), or manually enter stores. For example, the merchandising requestor may input a service request for a number of stores in the northeast US region, or a specific store in a particular city.

Although illustrative embodiments refer to selecting the “location,” it should be understood that a selection of a plurality of locations and/or all locations of a particular retailer (e.g., select all Best Buy locations that) qualifies as a selection of a location. Thus, the merchandising requestor may manually maintain, or have an automatically populated, list of locations in which their products are carried. As an example, the merchandising requestor may have various lists of clustered retail locations available as options (e.g., all locations of all available retailers, all locations of a particular retailer, all locations in a particular state of all available retailers, all locations of a particular retailer in a particular state, etc.). Thus, the retailer may select, for example, “All Dick's” to select all of the Dick's Sporting Goods locations in which a particular product is retailed. This creates a plurality of merchandising requests (at least one request for each of the locations under the selected group). In some embodiments, after the merchandising requestor selects the location for the service request 116, the management controller 108 compiles a list of available associates and filters the list for associates working in the selected locations to identify qualified associates.

FIG. 7 shows a screenshot of an exemplary interface for selecting desired skills for the service request 116 as in step 320. The merchandising requestor may select a group of skills created previously, or may manually select necessary skills. For example, the merchandising requestor may request that the retail associate have a “dairy” certification (e.g., the associate works or has worked in the dairy department of a supermarket). Furthermore, the skills may include an amount of experience or tenure at a retail location (e.g., 6 months or longer). In some embodiments, the management controller 108 filters the list of associates to exclude associates that do not have the selected skill(s) to identify qualified associates.

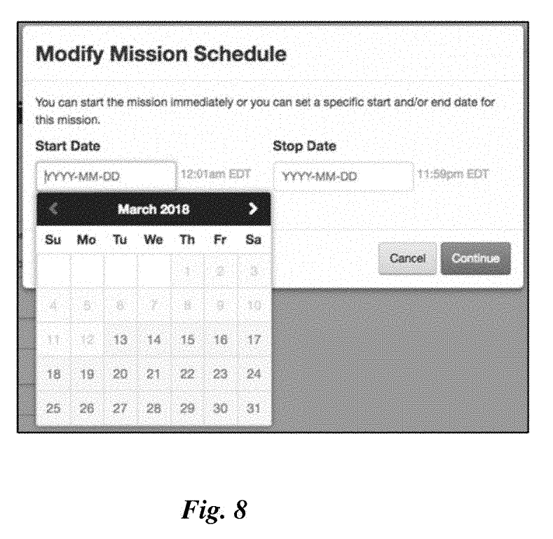

FIG. 8 shows a screenshot of an exemplary interface for selecting a time for performance of the service request 116 as in step 322. The merchandising requestor can request that performance of the service request 116 begin immediately, or they can select a specific start date and/or stop date. Furthermore, the merchandising requestor can specify the start time and/or stop time. In some embodiments, the service request is forwarded to the retailer workforce management platform 112 for review and approval by the retailer. The process of step 304 comes to an end and the service request 116 is created.

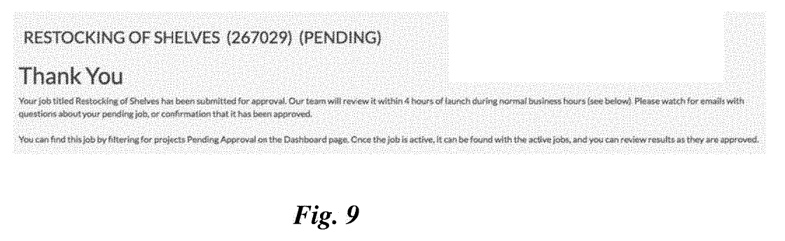

FIG. 9 shows a screenshot of a notification message 128 informing the merchandising requestor that the service request 116 was successfully created in accordance with illustrative embodiments of the invention. A similar notification may be sent to the selected retailer.

The process 300 in FIG. 3 then moves to step 306, where qualified retail associates are identified. This is done by comparing the service request parameters to the associate data from the pool of all available retail associates. FIG. 3B shows a detailed process of the step 306 of identifying qualified retail associates in FIG. 3. It should be noted that the method shown in FIG. 3A is substantially simplified from a longer process that may normally be used. Accordingly, the method of FIG. 3B may have many other steps that those skilled in the art likely would use. In addition, some of the steps may be performed in a different order than that shown, or at the same time. Furthermore, some of these steps may be optional in some embodiments. Accordingly, the process 306 is merely exemplary of one process in accordance with illustrative embodiments of the invention. Those skilled in the art therefore can modify the process as appropriate.

The process 306 begins at step 324, which receives associate data. After the service request 116 is created, at step 324 the merchandising initiative management controller 108 receives associate data from the retailer workforce management platform 112. At step 326, the management controller 108 identifies associates that work at the location specified in the service request 116. Accordingly, only associates who work at the specified location are considered qualified. The associate data used in the remaining of process 306 may be filtered to only associates who work at the specified location. Alternatively, associate data may be received from the workforce management platform 112 of the selected retail location. Additionally, or alternatively, the associate data may be provided by the associates, e.g., when they first opt in for the program. This information may include the retail associate's store(s), department(s), employment start date, or other skills. This information may be hosted within the associate platform 114, e.g., to minimize the number of queries made to the workforce management platform 112. Additionally, or alternatively, this data may be stored in the memory 4 of the controller. In some embodiments, retail stores (e.g., management) can check/confirm, (e.g., through the merchandising requestor platform), the accuracy of the associate data provided by the retail associate. Furthermore, the retail stores may have editing privileges for the associate data in some embodiments.

The associate data includes data relative to the criteria specified in the service request 116. At step 328, the management controller 108 identifies associates that have the skills specified in the service request 116. Accordingly, only associates who have the skills specified in the service request are considered qualified.

The process then proceeds to step 330, which identifies associates that have time to perform the service request 116. Among other things, the associate data may include work schedule of at least one retail associate that works at the selected retail location. The data may include the times and/or dates that the at least one retail associate is scheduled to work at the selected retail location. Thus, if there is a time range designated for completion of several days or weeks, the is merchandising initiative management controller 108 may identify retail associates in good standing that meet the parameters of the service request 116 and gives them the opportunity to claim the job.

At step 330, the process checks whether there is a specific day and time designated for the service (for example, product sampling on a particular Saturday afternoon), the merchandising initiative management controller 108 may identify retail associates that meet the parameters of the service request 116, and in some embodiments, are not scheduled to work at the retailer at the date and time specified in the service request. For example, the controller 108 compares retail associate data to identify retail associates who work at the selected retail location, and may disqualify the identified retail associates that are scheduled to work during the entire timeframe specified for the performance of the service request 116. It should be understood that not all embodiments disqualify associates on the basis of whether they are scheduled to work when the service request is to be performed. For example, there are instances where the service request may need to be performed by a certain date. Thus, in some embodiments, retail associates who are working on that date (i.e., the due date) may still be eligible to claim and perform the service request 116 prior to the date.

Furthermore, even if the retail associate is scheduled to work within the range, the retail associate may still be qualified as long as he has some period of time within the range that he is not scheduled to work. For example, if the service request must be completed between 9:00 AM and 6:00 PM, and the associate data indicates that the associate is scheduled to work from 9:00 Am to 5:00 PM, the associate may still be qualified. However, as described further below, access to the platform may be disabled for the associate during their work schedule, effectively preventing them from completing the tasks during their scheduled work period.

Although various steps are described during the qualification step 306, it should be understood that some steps are optional and customizable by the merchandising requestor. For example, the merchandising requestor may not input any desired associate skills in step 320. Accordingly, step 328 does not check whether the associate has skills in order to qualify the associate. Furthermore, some steps may come in a different order. For example, the associate data at step 324 may be received after the associate requirements are specified at steps 326-330.

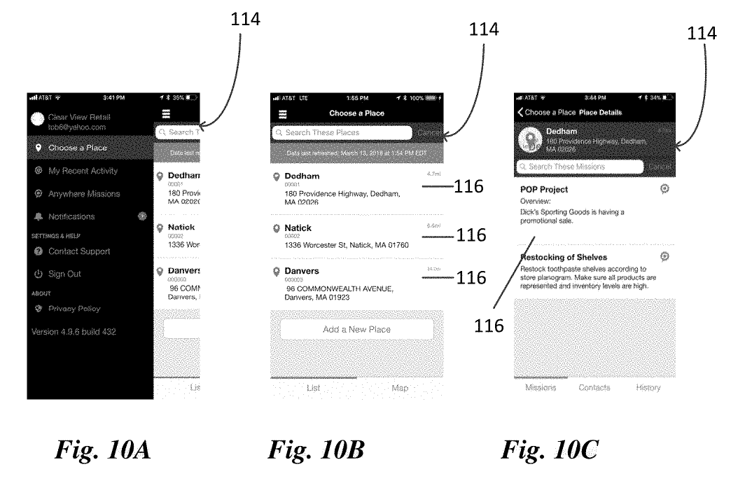

The process 300 of FIG. 3 then moves to step 308, where qualified retail associates are invited to accept the service request, e.g., via the retail associate platform 114. FIGS. 10A-10C show screenshots of an exemplary interface of the retail associate platform 114 in accordance with illustrative embodiments of the invention. Qualified retail associates may receive and view invitations to perform service requests, for example, through a mobile application distributed to retail associates (e.g., to be used on the retail associate's mobile device). Retail associates may view service requests 116 that they qualify for, by selecting, “Choose a Place” as shown in FIG. 10A. FIG. 10B is a screenshot showing an exemplary interface of the retail associate platform 114 where the user may see current service requests 116 that they qualify for. FIG. 10B shows three qualified service requests 116, (e.g., Dedham, Natick, Danvers Mass.). FIG. 10C is a screenshot showing the selected service request from FIG. 10B. Accordingly, the retail associate may view details relating to the selected service request 116 (e.g., time, place, tasks, etc.) before accepting.

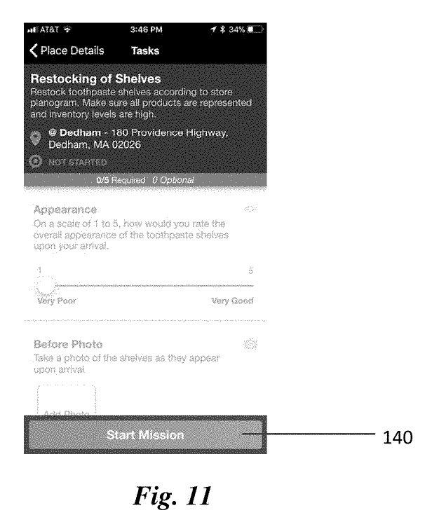

If the associate accepts the service request 116, the process 300 moves to step 310 where the service request 116 is assigned to the associate. FIG. 11 shows an interface on the retail associate platform 114 for accepting the service request 116. The retail associate may accept the service request 116 by selecting, for example, to “Start Mission” 140 on the interface. In some embodiments, associates claim jobs on a first come, first serve basis. After the job is claimed, it may be removed from the list of available jobs in other qualified associates' interfaces. However, in some embodiments, if the retail associate that claimed the project does not complete the project within a designated timeframe (e.g., 48 hours) the job may become available to other qualified retail associates. Additionally, in some embodiments, multiple associates may accept the same task and be paid on a first-to-complete the service request 116 basis. Furthermore, in some embodiments, both scheduling and execution of the service request 116 occur while the retail associate is off the retailer's clock.

At step 311, the management controller 108 enables the associate platform 114 when the assigned associate is not working. In other words, the associate platform 114 may become disabled (or in the alternative, selectively enabled) by the merchandising initiative management controller 108 as a function of the work schedule of the retail associate. For example, the initiative management controller 108 may disable functioning and/or access to the associate platform 114 while the retail associate is scheduled to work, and may re-enable the associate platform 114 at the conclusion of the associate shift. Accordingly, in some embodiments, the retail associate is not disqualified from the pool of qualified associates as a result of being scheduled to work, but instead, may not have access to the associate platform 114 while they are scheduled to work.

Although illustrative embodiments refer to accessing data relating to when the associate is scheduled to work, it should be understood that the data does not have to (but may) contain the exact times the employee is scheduled to work. Exact work times may be a concern, for example, for privacy reasons. Employers may also be unwilling to share this information. Another way to determine whether the employee is scheduled to work is to send an electronic query to the workforce management platform 12 when the service request 116 is started that asks whether the retail associate is on duty. If the answer is yes, all of the processes described previously and further below may proceed as if the associate is scheduled to work (e.g., the associate platform may be enabled). If the answer is no, the processes described previous and further below may proceed as if the associate is not scheduled to work (e.g., the associate platform may be disabled). Furthermore, in some embodiments, if the answer is no, the controller 108 may confirm whether there is enough time to complete the service request 116 before the associate's next shift starts (e.g., set by the merchandising requestor). In some embodiments, if there is not enough time, the associate platform 114 may be disabled.

In some other embodiments, the management controller 108 may disable access to a portion of the associate platform 114 when the associate is scheduled to work. Specifically, the part of the associate platform 114 that allows for the performance of the service request 116 (e.g., uploading pictures and/or answering a questionnaire) may be disabled. Therefore, in some embodiments, retail associates may accept service 116 requests while they are scheduled to work, but not perform them.

Furthermore, although the above process describes creating a service request using one location and one associate, it should be understood that illustrative embodiments may include a plurality of locations and/or a plurality of associates. For example, in step 304 the service request may include a plurality (also referred to as a cluster) of locations (e.g., “Best Buys in Massachusetts”). The processes 306-314, and other described processes, may then proceed for each of the locations (e.g., in parallel). Accordingly, a plurality of retail associates may be assigned to each service request, respectively. Furthermore, in some embodiments, a large task may require a plurality of retail associates. Thus, some service requests may be performed by a plurality of associates. Accordingly, step 311 may apply to each retail associate based on their respective work schedule.

Presently a problem exists in that retail employees can perform third-party services while they are on-duty at the retailer. Illustrative embodiments provide a technical solution to this problem in that the management controller 108 prevents “double-dipping” of time by retail associates, e.g., the retail associates cannot fulfill service requests 116 while they are on duty working at the location on behalf of the retailer. Furthermore, another advantage is that the system 106 identifies retail associates that work at the specific location, and thus, have familiarity with the selected retail location. This provides the retailer with peace of mind, as unknown third parties are not coming into the store and performing merchandising initiatives. In some embodiments, retail associates that work at any location of a specified retailer (e.g., an employee of any Best Buy, rather than from a specific Best Buy), or within a specified radius, are also eligible. A further advantage of illustrative embodiments is that merchandising requestors (e.g., startups) may simultaneously employ a plurality of retail associates to assist with merchandising projects. The retail associates may be located in different geographies, and hired on an as-needed basis, effectively enabling companies to run merchandising projects across the country in a cost-efficient manner.

The process then moves to step 312 where the service request 116 is performed by the one or more retail associates. In illustrative embodiments, service requests 116 are completed before or after shifts, not while on the clock for the retailer. In some embodiments, the retail associate platform 114 is disabled while the associate is scheduled to work, even if the associate has accepted the request. The retail associate platform 114 is re-enabled after the associate's shift has come to an end, at which point, the associate can complete the service request 116. To that end, the retail associate's shift data (e.g., time and day scheduled to work) may be included in the retail associate data. In some embodiments, the retail associate must verify their location using GPS to perform and complete the service request 116. The GPS data prevents inaccurate or fraudulent reporting from different locations. Additionally, in some embodiments, the GPS data also prevents the pre-capturing of images and/or performance of tasks during work shifts that are submitted after the associate's work shift.

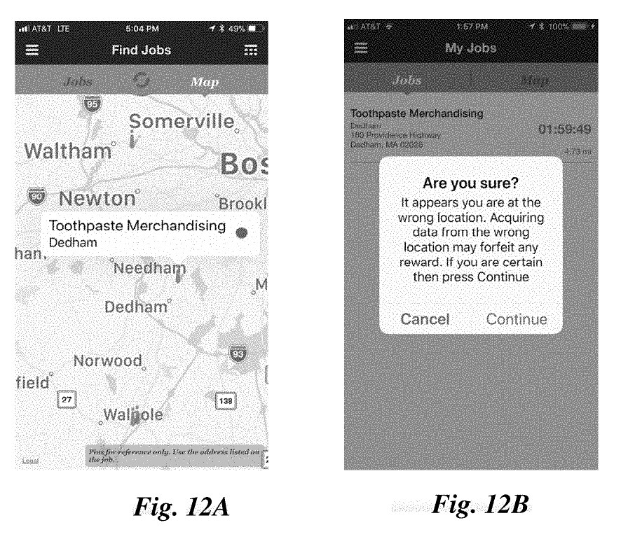

FIG. 12A shows a GPS interface of the retail associate platform 114 in accordance with illustrative embodiments of the invention. A problem that exists in the art is that retail associates may fraudulently claim to have performed the service, or perform the service at the wrong location. Illustrative embodiments provide a technical solution wherein the GPS module confirms that the retail associate is performing the service request 116 at the selected retail location. Thus, retail associates, retailers, and merchandising requestors can confirm that the retail associate is performing the service request at the correct location. FIG. 12B shows an example of a message informing the retail associate that they are at the wrong location. In some embodiments, the associate platform 114 is selectively enabled based on the associate's GPS position. For example, illustrative embodiments may selectively enable the associate platform when the associate is within some predefined distance to the selected location (e.g., at the location, within 100 meters, within 1 mile, within the city, etc.).

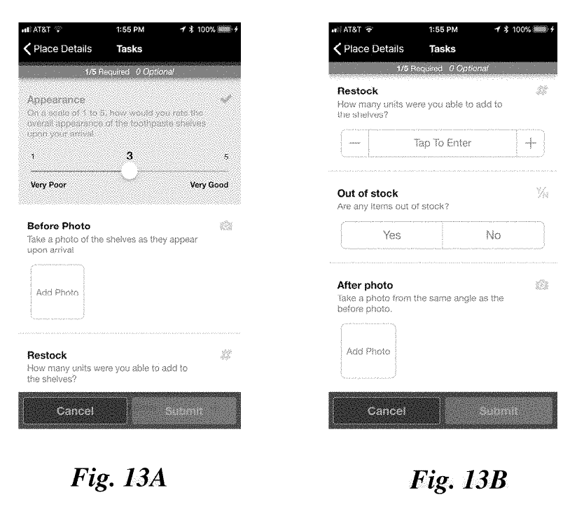

The retail associate then prepares a report at step 314. FIGS. 13A-13B show screenshots of an exemplary interface for preparing a report in accordance with illustrative embodiments of the invention. Again, in some embodiments, preparing a report is disabled while the retail associate is scheduled to work. The report may include before and after photos, a rating of the compliance of the retailer with the merchandising initiative, and other answers to questionnaires prepared by the merchandising requestor. FIGS. 13A-13B show screenshots of an interface for preparing the report. The report allows merchandising requestors and retailers (e.g., store managers) to audit their performance and/or compliance with merchandising initiatives. Additionally, the work may be anonymously peer reviewed. Retailers and/or merchandising requestors can use the merchandising reports to review sales numbers and quantify return on investment in merchandising initiatives. The report may be stored by the system 106 and viewable by vendors, store ops, buyers and/or store management.

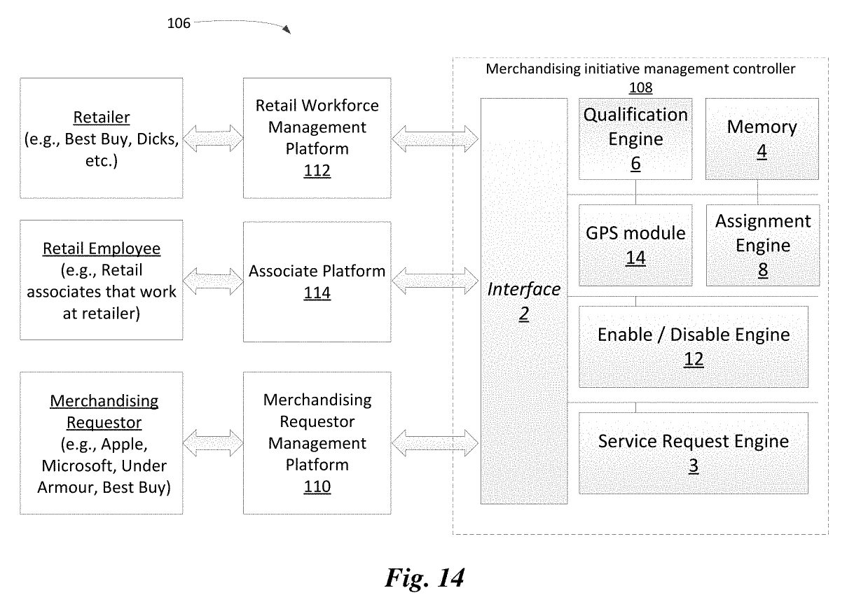

FIG. 14 shows details of the controller 108 in accordance with illustrative embodiments of the invention. The controller 108 has an interface 2 configured to communicate with the retail workforce management platform 112, the associate platform 114, and the merchandising requestor management platform 110. The interface 2 sends and receive data to and from the platforms 110-114. For example, the interface 2 receives the associate data from one or more of the retail workforce management platform. Additionally, the interface 2 receives the service request 116 from the merchandising requestor management platform 110.

As described previously, accessing data about when the associate is scheduled to work may include sending an electronic query through the interface 2 to the workforce management platform 112 to determine whether the employee is scheduled to work at the time of the query. For example, this electronic query may be sent at the time the retail employee attempts to begin or complete a service request. Providing the data relating to whether the associate is scheduled to work in this format may assist with addressing privacy concerns relating to divulging specific times that associates are working. The controller 108 may initiate this request, for example, when the associate tries to perform the service request 116 and/or at the time the associate tries to access the associate platform 114.

The controller 108 has a memory 4 in which the associate data, service requests, and other information used by the controller may be stored. In some embodiments, associate data from a plurality of retailers may be stored on the memory 4 and accessed as needed. Alternatively, associate data from the retailers may be accessed on as needed basis and stored thereon after. In some embodiments, the merchandising requestor may leave a rating and/or review of the assigned associate. This rating and/or review may be stored in the memory 4 and compiled with other ratings and/or reviews to produce a compiled rating and/or review.

The controller 108 has a service request engine 3 that allows the merchandising requestor to create the service request 116. As described previously, there are a number of fields for the service request 116. The service request 116 receives the specifications in the service request, and communicates that information to a qualification engine 6.

The qualification engine 6 takes the specifications in the service request 116 and compares them to the associate data. The qualification engine 6 qualifies one or more associates whose associate data meets the specification(s) in the service request 116. The qualification engine 6 may access the associate data directly from the workforce management platform 112 and/or from data stored in the memory 4.

An assignment engine 8 may communicate with the associate platform 114 to send an invitation to perform service requests 116 to one or more retail associates, as shown in FIGS. 10A-10C. Although described as an “invitation,” there is no formal addressing or smartphone notification necessary. Instead, the invitation may automatically populate, and may also be referred to as an available service request 116. In some embodiments, the invitation to perform service requests are sent to qualified retail associates. Accordingly, the assignment engine 8 may communicate with the qualification engine 6 and/or memory 4 to access information relating to which retail employees are qualified. The retail associate(s) that received the invitation to perform service request (e.g., the qualified associate) may then accept the service request 116 through the associate platform 114. The acceptance is communicated to the assignment engine 8, which then defines the associate(s) that accepted the job as assigned associate(s). In some embodiments, the service request 116 may specify the number of assigned associate(s) needed (e.g., 1 employee). After the requisite number of associate(s) is assigned, the assignment engine 8 may withdraw outstanding invitations to perform the service requests 116.

The controller 108 also has an enable module 12. In some embodiments, the enable module may additionally, or alternatively, be a disable module 12. After the retail associate has been assigned the service request 116, the enable/disable module 12 accesses the assigned associate's work schedule. This information may be accessed directly from the workforce management platform 112, or it may alternatively be accessed from stored memory 4. The associate platform 114, or a portion thereof, is disabled for the assigned associate during scheduled work shifts at the retailer. Accordingly, “double dipping” by performing the service request 116 while working at the retailer is effectively prevented. In some embodiments, only the portion of the associate platform 114 that allows viewing and/or completion of the tasks in the service request 116 is disabled during the assigned employee's scheduled work period. Thus, the full functionality of the associate platform 114 is enabled when the associate is not scheduled to work. The associate platform may thus be selectively enabled by the assignment enable module 12.

To further prevent double-dipping, the controller 108 may also have a GPS module 14. The GPS module 14 communicates with the associate platform 114 to determine the GPS location of the retail employee's mobile device. Additionally, the GPS module communicates with the enable engine 12. The GPS module may send a message to the enable engine 12 when the employee is at the location specified in the service request 116 to enable the associate platform 114 as described previously. Additionally, or alternatively, the GPS module may send a message to the enable engine 12 when the employee is not at the location specified in the service request 116 to disable the associate platform 114. Accordingly, completion of the tasks in the service request 116 is performed at the correct retail location while the employee is at the retail location (e.g., instead of the employee taking pictures during their work shift and then uploading the pictures to complete the task).

Each of the above-described components is operatively connected by any conventional interconnect mechanism. FIG. 14 simply shows a bus communicating each of the components. Those skilled in the art should understand that this generalized representation can be modified to include other conventional direct or indirect connections. Accordingly, discussion of a bus is not intended to limit various embodiments.

Indeed, it should be noted that FIG. 14 only schematically shows each of these components. Those skilled in the art should understand that each of these components can be implemented in a variety of conventional manners, such as by using hardware, software, or a combination of hardware and software, across one or more other functional components. For example, the assignment engine 8 may be implemented using a plurality of microprocessors executing firmware. As another example, the GPS module 14 may be implemented using one or more application specific integrated circuits (i.e., “ASICs”) and related software, or a combination of ASICs, discrete electronic components (e.g., transistors), and microprocessors. Accordingly, the representation of the components in a single box of FIG. 14 is for simplicity purposes only. In fact, in some embodiments, the GPS module 14 of FIG. 14 is distributed across a plurality of different machines—not necessarily within the same housing or chassis. Additionally, in some embodiments, components shown as separate (such as the Enable Engine 12 and the Assignment Engine 8 in FIG. 14) may be replaced by a single component. Furthermore, certain components and sub-components in FIG. 14 are optional. For example, some embodiments may not use the GPS module 14.

In illustrative embodiments, each of the platforms may have APIs that enable direct integration/interface. In some other embodiments, the platforms may provide data in a table. Without intending to limit illustrative embodiments of the invention, one example of the workforce management platform 112 may be Kronos® Workforce Timekeeper, Infor® WFM/Workbrain, Oracle® (PeopleSoft) Time & Labor, JDA® Workday and/or other workforce management systems.

It should be reiterated that the representation of FIG. 14 is a significantly simplified representation of the management controller 108. Those skilled in the art should understand that such a device may have other physical and functional components, such as central processing units, other packet processing modules, and short-term memory. Accordingly, this discussion is not intended to suggest that FIG. 14 represents all of the elements of the management controller 108.

A person of skill in the art understands that illustrative embodiments provide a number of advantages. For example, requests for merchandising initiatives may be performed by seasoned employees who know the store well, rather than from outsiders. This can be additionally advantageous in retail locations that are in remote locations/sparsely populated, as service requests 116 are fulfilled from the existing employee base. Merchandising issues may be quickly identified, and service requests may be created and resolved quickly. Competition for projects with a focus on people already working in the stores combines the quick turnaround and cost-effectiveness of crowdsourcing with an ability to solve issues that are uncovered in the process.

Other advantages of illustrative embodiments include that retailers may earn revenue for each project completed, and retail associates can make money for working different hours for a different employer at the same retail location (e.g., no travel costs when accepting service requests after your shift). This in turn may lead to increased retention of store associates because they have a higher earning potential and more hours/incentives to stay on the job. Illustrative embodiments provide advantages for merchandising requestors including identifying disparities in store displays and presentation that might be impacting sales, while minimizing recruiting costs associated with traditional third party merchandisers. Additionally, some embodiments do not require a background check because the retailer has already vetted the retail associate.

Additional advantages of illustrative embodiments include peer auditing as part of the project execution, which eliminates the need to finance a separate auditing process. Shared access to projects and reporting provides greater visibility, communication, and collaboration among all parties. Illustrative embodiments provide greater employee accountability—the ability to identify consistent superior performers enables brands and retailers to steer more projects in the direction of those individuals. Employees that don't consistently meet expectations can get additional training. Additionally, merchandising requestors using the platform may earn greater mind-share of store associates.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation is (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Disclosed embodiments, or portions thereof, may be combined in ways not listed above and/or not explicitly claimed. In addition, embodiments disclosed herein may be suitably practiced, absent any element that is not specifically disclosed herein. Accordingly, the invention should not be viewed as being limited to the disclosed embodiments.

The embodiments of the invention described above are intended to be merely exemplary; numerous variations and modifications will be apparent to those skilled in the art. Such variations and modifications are intended to be within the scope of the present invention as defined by any of the appended claims.

What is claimed is:

1. A merchandising initiative management system comprising:
a merchandising initiative management controller configured to electronically interface via a network with at least one retailer workforce management platform, at least one merchandising requestor management platform, and at least one associate platform,
the management controller further configured to:
receive a merchandising service request from a merchandising requestor platform, the service request having specifications including a task and a selected retail location for performance of the task,
receive associate data from the workforce management platform of the selected retail location, the associate data relating to a work schedule of a retail associate that works at the selected retail location,
assign the retail associate to the service request, thereby defining an assigned associate, and
selectively enable use of the associate platform to complete the task as a function of the work schedule of the assigned associate.

2. The system as defined by claim 1, wherein the management controller is configured to:
compare the specifications in the service request with the associate data of the retail associate to determine one or more qualified associates who match and/or meet the specifications,
provide an invitation to perform service request through the associate platform to the one or more qualified associates, and
receive an acceptance of the invitation to perform service request from one or more of the qualified associates.

3. The system as defined by claim 1, wherein the service request specification includes a plurality of retail locations, and a plurality of retail associates are assigned to the plurality of retail locations, respectively

4. The system as defined by claim 1, wherein the associate data includes the times and dates the retail associate is scheduled to work at the selected retail location, and/or an indication of whether the associate is working at the time the data is received.

5. The system as defined by claim 1 wherein the specifications in the service request include a time range for performance of the task.

6. The system as defined by claim 1 wherein the specifications in the service request include a deadline by which the service needs to be completed.

7. A method of booking a merchandising service request, the method comprising:
providing a merchandising initiative management controller configured to electronically interface with at least one retailer workforce management platform, at least one merchandising requestor management platform, and at least one associate platform,
the merchandising initiative management controller configured for:
allowing a merchandising requestor to create a service request including a retail location, and a performance time range,
qualifying retail employees that meet the requirements in the service request, to produce a list of qualified retail employees,
inviting the qualified retail employees to perform the service request,
receiving an input from the qualified retail employees as to whether they accept or decline the service request, and
assigning the service request to at least one qualified employee to define at least one assigned employee,
disabling use of the associate platform of the assigned employee during the scheduled shift of the assigned employee.

8. The method as defined by claim 7, further comprising selectively enabling use of the associate platform of the retail associate as a function of the work schedule of the retail associate.

9. The method as defined by claim 7, wherein the associate data further comprises: associate tenure and/or associate skills.

10. The method as defined by claim 7, wherein the service request includes associate skills.

11. The method as defined by claim 7, wherein the service request includes a pay rate.

12. The method as defined by claim 7, wherein the service request is created from the merchandising requestor management platform.

13. A non-transitory computer-readable medium encoded with instructions that, when executed by a processor, establish processes for performing a computer-implemented method of creating a merchandising initiative service request, the processes comprising:
receiving scheduled work shifts of retail employees;
interfacing with a merchandising requestor management platform to receive a service request having specifications including a location for performance of the service;
qualifying retail employees that meet the specifications of the service request to produce a list of qualified retail employees;
interfacing with a retail associate platform to invite the qualified retail employees to perform the service request, and to receive an input from the qualified retail employees as to whether they accept or decline the service request;
assigning the service request to at least one qualified retail employee; and
disabling the associate platform of the at least one qualified retail employee during a scheduled retailer shift.

14. The processes as defined by claim 13, further comprising:
preparing a report relating to the service request and the at least one qualified retail employee.

15. The processes as defined by claim 13, wherein the associate data further comprises at least one of: associate tenure and/or skills.

16. The processes as defined by claim 13, wherein a directive and reporting portion of the associate platform is disabled and re-enabled.

17. The processes as defined by claim 13, wherein the service request includes a pay rate.

18. The processes as defined by claim 13, wherein the service request is created from the merchandising requestor management platform.

19. The processes as defined by claim 13, wherein the service request includes detailed guidance on steps for the associate to follow to complete the service.

20. The processes as defined by claim 13, further comprising enabling the associate platform of the at least one qualified employee at the conclusion of the scheduled retailer shift.
